(19) United States
(12) Patent Application Publication
(10) Pub. No.: US 2014/0348429 A1
(43) Pub. Date: Nov. 27, 2014

(54) OCCUPANCY DETECTION

(71) Applicant: OSRAM GmbH, Muenchen (DE)

(72) Inventors: Amit Kale, Bangalore Karnataka (IN); Chhaya Methani, Bangalore Karnataka (IN)

(73) Assignee: OSRAM GmbH, Muenchen (DE)

(21) Appl. No.: 14/284,413

(22) Filed: May 22, 2014

(30) Foreign Application Priority Data
May 22, 2013 (IN) 2241/CHE/2013

(51) Int. Cl. G06K 9/62; G06K 9/00

(52) U.S. Cl. CPC G06K 9/6267; G06K 9/00624
USPC 382/170; 382/203

(57) ABSTRACT

A method for occupancy detection is disclosed. The method may include capturing an image, moving a sliding window over said image, determining features for intensity image and gradient image, generating a strong classifier, detecting shape of object; and determining occupancy.

### CROSS-REFERENCE TO RELATED APPLICATION

This application claims priority to Indian Patent Application Serial No. 2241/CHE/2013, which was filed May 22, 2013, and is incorporated herein by reference in its entirety.

### TECHNICAL FIELD

Various embodiments relate to a method and a system for occupancy detection. In particularly, various embodiments relate to occupancy detection using visual information technology algorithms.

### BACKGROUND

Occupancy detection for better light management has been a prime focus of building technologies with the goal of energy savings. While simple motion detectors have been used for this purpose, they do not work well when the human is stationary for a long period of time. Passive Infra Red (IR) sensors that measure the heat level in the room are already being commercially deployed. These low cost passive IR sensors are robust in person detection but work at a shorter range of around 3 meters. It is also expected that even if a person is stationary, the same should be detected; which is not the case with a motion detector.

Another problem with IR sensing is its lack of intelligence in discriminating between the various sources of heat. In a warehouse, a distinction needs to be made between a human and non-human viz, a moving conveyor belt. It is with the intent of detecting humans at a distance and to distinguish between human and non-human targets, stationary or moving, the present disclosure looks for alternative methods to expand the scope of occupancy detection. While motion sensors using ultrasonic waves can extend the range substantially, problems related to lack of Intelligence in distinguishing between human and non-human still remain.

### SUMMARY

The present disclosure uses visual information technology algorithms to solve the problem of occupancy detection by using a camera sensor in place of an IR sensor. In present era, the visual data capture cost has reduced significantly on account of cheap generic web cameras coupled with advancements in image analytics. A video stream provides more information about the contents of the scene than an IR sensor that captures the change in movement of hot objects.

Although, visual information from the frontal view has been used in the past for detection of humans, there have been problems of people being occluded due to the objects placed in front of them and due to the presence of other people. Hence, the present disclosure proposes a camera mounted on the ceiling to get an unobstructed view of the scene. Most of the literature, focuses on solving the problem of person detection from a frontal view due to the richness of the feature vectors obtained from a frontal profile.

Further, few publications consider an overhead view aim to detect events in applications like assisted living (for fall detection) and counting of people while entering a mall. The inherent presence of motion cues in the detection of these activities supplements the limited availability of features in the overhead view. However, occupancy detection entails identifying the presence of people in an indoor environment, where the person may be stationery for long durations of time.

To overcome the above identified limitations there is a need for a solution that provides an efficient and simple automatic recognition of humans from an overhead view irrespective of the movement of the person.

Accordingly, various embodiments provide a method and system for occupancy detection in environments where people are stationary for long durations of time.

Various embodiments further provide an efficient method and system for occupancy detection.

Various embodiments still further provide a less complex method and system for occupancy detection.

Various embodiments provide a method for occupancy detection including the steps of capturing an image; moving a sliding window over said image; determining features for intensity image and gradient image; generating a strong classifier; detecting shape of object; and determining occupancy.

According to various embodiments, a training stage and a testing stage is provided for head detection wherein the step of moving a sliding window over the image for extracting image regions includes moving square window of dimensions P×P over the image, where value of p is varied from a fixed minimum value which is 16 to N/2 wherein N is min(X,Y) where X,Y is the size of the image. The step of moving a sliding window further includes resizing the window to a fixed size of 16×16 to ensure uniformity of feature computation.

According to various embodiments, the step of determining features for intensity image and gradient image comprises determining Haar features over intensity image; HoG features over intensity image; and HaaR features over gradient image.

According to various embodiments, the step of determining HoG features includes taking gradient of the 16×16 image and dividing the same into a 4×4 cell grid where each cell has 4×4 pixels. The step of determining HoG features further includes mapping each cell to a histogram containing 8 bins, where each bin represents the gradient slope variation of Pi/8. Thereafter, all groups of 2×2 cells from the grid are grouped to define a block. Features for each block are formed by concatenating the histograms of the cells including it. HOG features for the image are then generated by concatenating features for consecutive blocks as shown in the figure.

According to various embodiments, the step of determining HaaR features includes computing an internal image for each image region where the internal size of image is 16×16.

According to various embodiments, the step of generating a strong classifier includes selecting most discriminatory feature at every stage iteratively with a Adaboost classifier and combining such discriminatory features to construct a strong classifier.

According to various embodiments, the step of determining occupancy includes applying smoothness constraint to classifier output by using a simple voting strategy wherein a sliding window updates to a new frame and takes voting for last 9 frames along with current frame.

Various embodiments also provide a system for occupancy detection comprising a means for capturing (102) an image; a means for processing (104) a captured image; and a means for switching (106) based on detection of objects.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various embodiments of the disclosure are described with reference to the following drawings, in which:

FIG. 1 illustrates the block diagram for occupancy detection system according to preferred embodiment of the present disclosure,

FIG. 2 illustrates a flowchart for occupancy detection according to the present disclosure,

FIG. 3 illustrates concatenation of the histograms of various parts of the image according to the present disclosure,

FIG. 4 illustrates Haar wavelets,

FIG. 5 illustrates value of integral image at point (x,y),

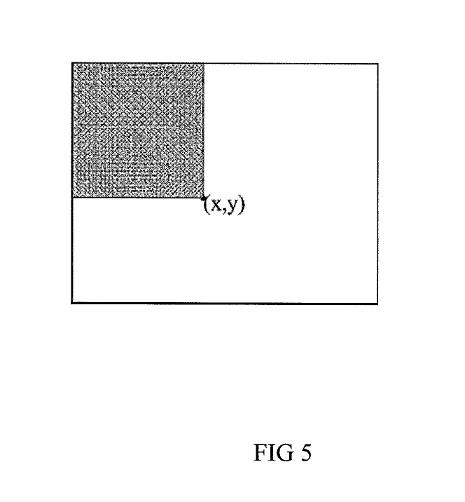

FIG. 6 illustrates results of videos collected in House-testing, and

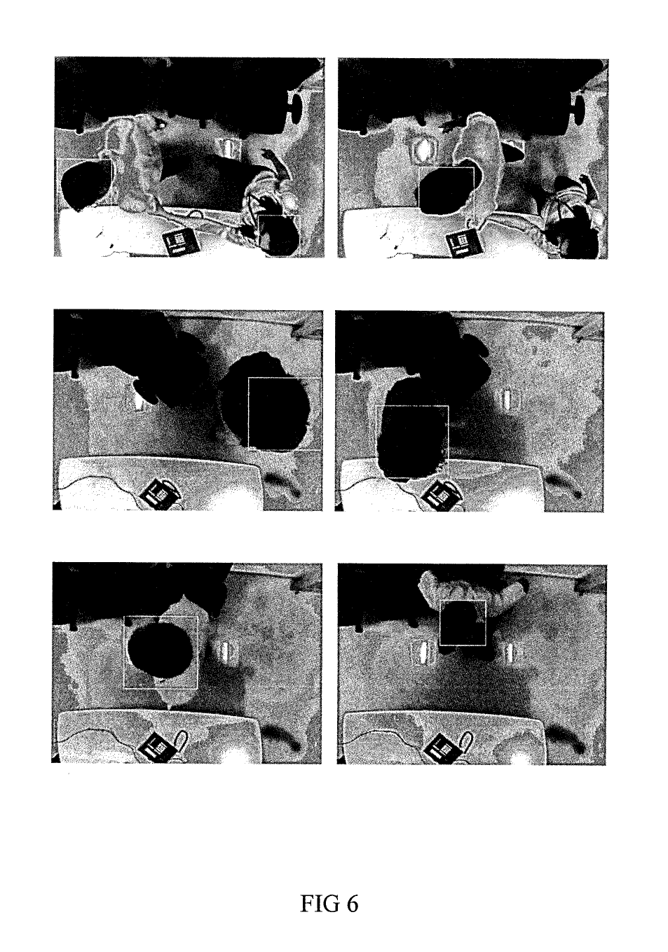

FIG. 7 illustrates variations in the head pose of a human subject according to the present disclosure.

### DETAILED DESCRIPTION

The present disclosure is described hereinafter by various embodiments with reference to the accompanying drawings, wherein reference numerals used in the accompanying drawings correspond to the like elements throughout the description. In order to achieve full description and explanation, specific details have been mentioned to provide a thorough and comprehensive understanding of various embodiments of the present disclosure. However, said embodiments may be utilized without such specific details and in various other ways broadly covered herein. Known features and devices have been shown in the form of block diagrams to prevent redundancy and for the sake of brevity. Further, the block diagrams have been incorporated to facilitate description of one or more embodiments.

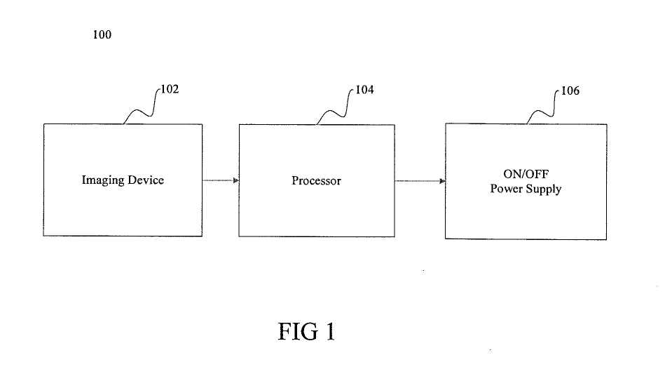

FIG. 1 is a block diagram illustrating a system for occupancy detection according to a preferred embodiment of the present disclosure. The disclosed system (100) comprises of a means for capturing (102) an image, a means for processing (104) the captured image and a means for switching based on detection of humans in the area.

According to one of the preferred embodiment of the present disclosure, the means for capturing (102) the image includes a camera sensor mounted to capture images from the top view. In the present disclosure any generic web camera can be used to capture images. A person while moving around in an office space can undergo a multitude of pose changes viz, standing, sitting, leaning, sitting cross legged etc. Detecting all these different poses would mean training various different classifiers to detect each one of these poses, which is a computationally extensive task and reduces the efficiency.

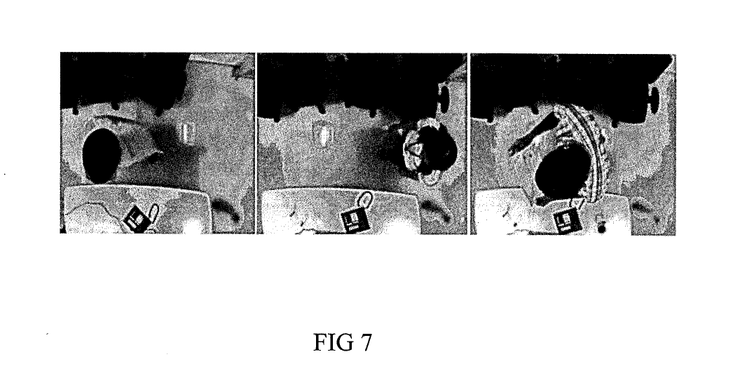

Hence, the present disclosure uses head detection to efficiently detect the stationary humans. As illustrated in FIG. 7, irrespective of the pose assumed by the person and the direction being faced, the head shape doesn't change much and the detection can be done using a single classifier.

According to one of the preferred embodiment of the present disclosure, the means for processing (104) comprises of micro-processor which is connected to the camera sensor. The microprocessor processes the images captured by the sensor and based on the presence of a person controls a switching means (106).

According to yet another preferred embodiment of the present disclosure, the means for processing (104) can be incorporated in the camera sensor or externally connected.

According to yet another preferred embodiment of the present disclosure, the system (100) includes a display or indicator (not shown in the figure) to display or indicate the current status of the system.

According to yet another preferred embodiment of the present disclosure, the display or indicator is placed remotely.

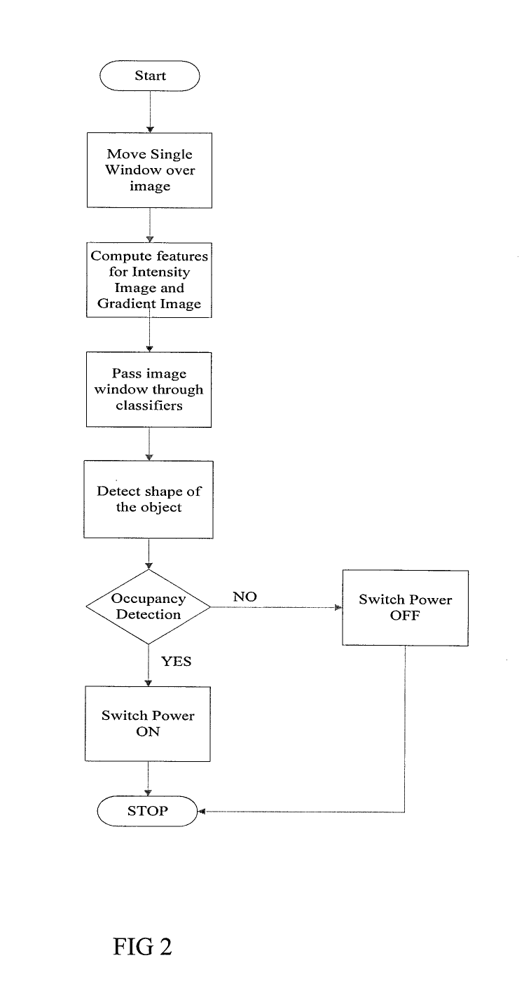

FIG. 2 is a flow chart illustrating the method for occupancy detection according to a preferred embodiment of the present disclosure.

According to a preferred embodiment, the present disclosure has a training and testing stage for head detection. Both the phases start with extracting image regions using a sliding window. Said sliding window approach is used for feature computation using a single window approach wherein a square window of dimensions P×P is moved through the image. The value of P is varied from a fixed minimum value. This minimum value may be varied from 16 to N/2, where N=min (X, Y) where X, Y is the size of the image. These windows so generated are then resized to a fixed size of 16×16 to ensure uniformity of feature computation. Therefore each image of size 480×640 gives a set of 2236 regions.

According to a preferred embodiment, features computed from the windows are passed though the classifier. Since the main feature to be detected are those containing the shape of the head, only the below mentioned features are utilised:

HaaR feature over intensity image.

HoG feature over gradient image.

HaaR feature over gradient image.

According to a preferred embodiment, HoG features are computed on an image by first taking the gradient of the image. The 16×16 gradient image is then divided into a 4×4 cell grid with each cell has 4×4 pixels. Each cell is mapped to a histogram containing 8 bins, wherein each bin represents the gradient slope variation of Pi/8. For eg., a vertical line would have a slope of 90 and hence all pixels would map to the bin representing 90 degrees.

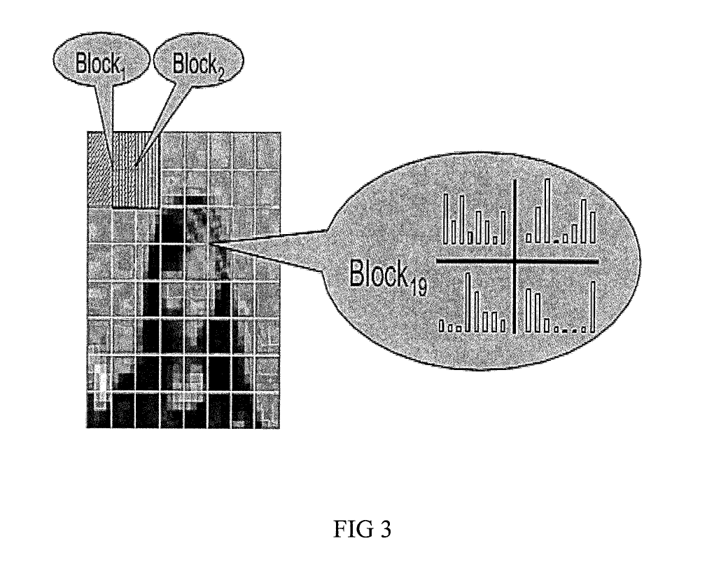

The bin populations of consecutive blocks are concatenated resulting in a feature vector of length 288. The demarcation used for defining consecutive blocks of size 2×2 cells has been illustrated in FIG. 3. These numbers are arrived at considering the representation capacity and computational complexity of the features.

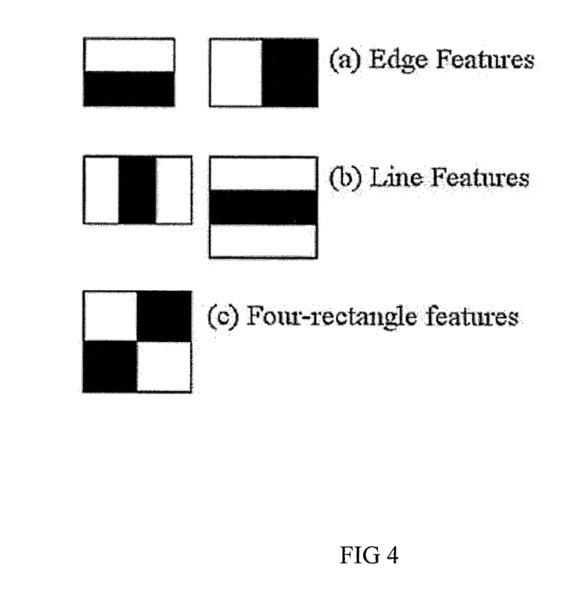

According to another embodiment, for calculating HaaR features, an integral image is first computed for each image region. This integral image is of the size 16×16 as indicated in FIG. 4.

The present disclosure uses a method of image representation through generation of an integral image. The advantage of using an integral image is that it can be computed using few operation per pixels. Having computed the integral image the HaaR features are then calculated for these images at any location or scale in constant time. This method provides for very fast feature computation. For an integral image, located at point (x,y), the sum of pixels above and to the left of the said point can be denoted as follows:

$$ii ( x , y ) = {\sum }_{{x}^{′} \leq x , {y}^{′} \leq y}^{ } i ( {x}^{′} , {y}^{′} ) .$$

where ii (x, y) is the integral image and i (x, y) is the original image.

To calculate the integral image using a single pass over, the following pair of recurrences are used:

s(x, y)=s(x, y−1)+i(x, y) (1)

ii (, y)=ii(x−1, y)+s(x, y) (2)

where, s(x, y) is the cumulative row sum, s(x,−1)=0, and ii(−1, y)=0.

The rectangular sum can be calculated in four array references using the integral image. To calculate the difference between two rectangular sums, eight array references are required. Similarly, to calculate the features of adjacent rectangles, six array references are required and so on.

These features are calculated for both intensity image and gradient image. Gradient image is included to highlight the importance of shape in the feature vector. Having included HoG and HaaR features for both intensity and gradient images, total length of the vector thus generated is:

$$= ( HaaR feature for intensity image ) + ( HaaR feature for gradient image ) + ( HoG feature for gradient image ) \\ = 7236 + 7236 + 288 \\ = 14760$$

According to preferred embodiment, the next step is to pass the image windows through a suitable classifier. Since the features are all heterogeneous, AdaBoost classifier is used in the present disclosure. The AdaBoost classification algorithm iterates through all the features, and selects the most discriminating feature at every stage. Each such feature selected is designated a weak classifier. The performance given by such weak classifiers are marginally better than decisions taken randomly. A total of 50 such weak classifiers are selected to construct a strong classifier. Having selected a strong classifier the next step is to select a suitable threshold for classifying samples in the test phase.

From the selected weak classifiers it is evident that these classifiers work predominantly on HoG features. The reason for this is because shape of the head from an overhead angle is the strongest cue available. Thus, most of the distinguishing features are located along the edge of the head defining the curvature of the head. The inclusion of features of gradient image adds the advantage that features are not thereafter affected by the colour of person's hair i.e. hair of any colour should be equally identifiable.

According to a preferred embodiment, temporal smoothness constraint is used in detection process. This is used to deal with misdetections and false positives. Depending upon prior knowledge of the scene, constraints are applied to the detector outcome to improve the classification performance. Due to this constraint, there shall always be an entry and exit associated with the person and each motion will be continuous in space and time. This helps to account for sudden misses or spurious detections.

Different types of smoothing algorithms are available, however the present disclosure applies simple voting strategy. In doing so, a sliding window is selected of 10 units. Whenever a new frame comes, the sliding window updates to the new location and takes voting over the last 9 frames along with the current frame. The verdict of the majority of these frames is then assigned to the frame in question. Therefore, in such manner, the present disclosure is able to avoid the errors caused due to sporadic variations in sensor noise and lighting.

The detection algorithm provides information regarding scale and location of the object in space and time. However the current disclosure does not require this information. The only information required is that whether the object is present or not. The additional information can be used to put further constraints like continuity of scale and location change.

According to a preferred embodiment, for training and testing the classifier a total data of 12 subjects was taken. Of the total, 9 were used to train the classifier and 3 were used to test the classifier. Positives samples were also synthetically rotated to generate new data. The classifier was trained with a total of 4656 positive samples and 12000 negative samples.

The classifier was tested on 3 videos and results were benchmarked. The benchmarking is done by checking the overlap between the ground truth and the regions found by the classifier. The overlap region is determined by the following:

overlap=(R_{GT} ∩ R_{evaluated})/(R_{GT} Å R_{evaluated});

The threshold that is applied to the overlap determines whether the overlap is more or less than the threshold value.

Various modifications to these embodiments are apparent to those skilled in the art from the description and drawings herein. The principles associated with the various embodiment defined herein may be applied to other embodiments. Therefore, the description is not intended to be limited to the embodiments shown along with the accompanying drawings but is to be provided broadest scope consistent with the principles and novel and disclosure features describe/disclosed or suggested herein. Any modifications, equivalent substitutions, improvements etc. within the spirit and principle of the present disclosure shall all be included in the scope of protection of the present disclosure.

What is claimed is:

1. A method for occupancy detection comprising:
capturing an image;
moving a sliding window over said image;
determining features for intensity image and gradient image;
generating a strong classifier;
detecting shape of object; and
determining occupancy.

2. The method as claimed in claim 1, wherein square window of dimensions P×P is moved over the image, where value of P is varied from a fixed minimum value which is 16 to N/2.

3. The method as claimed in claim 2, wherein N is min(X,Y) where X,Y is the size of the image.

4. The method as claimed in claim 2, wherein the window is resized to a fixed size of 16×16 to ensure uniformity of feature computation.

5. The method as claimed in claim 1, wherein said determining features for intensity image and gradient image comprises determining
Haar features over intensity image;
HoG features over intensity image; and
HaaR features over gradient image.

6. The method as claimed in claim 5, wherein said determining HoG features includes taking gradient of the image and dividing the same into a 4×4 cell grid where each cell has 4×4 pixels.

7. The method as claimed in claims 5, wherein said determining HoG features further comprises mapping each cell to a histogram containing 8 bins, where each bin represents the gradient slope variation of Pi/8.

8. The method as claimed in claims 5, further comprises defining blocks in the cell grid in 2×2 cells.

9. The method as claimed in claim 8, further comprising concatenating bin populations of consecutive cells.

10. The method as claimed in claim 5, wherein said determining HaaR features includes computing an internal image for each image region where the internal size of image is 16×16.

11. The method as claimed in claim 1, wherein said generating a strong classifier includes selecting most discriminatory feature at every stage with an Adaboost classifier.

12. The method as claimed in claim 11, wherein said discriminatory features are combined to construct a strong classifier.

13. The method as claimed in claim 1, wherein said determining occupancy includes applying smoothness constraint to classifier output.

14. The method as claimed in claim 13, further comprises applying simple voting strategy wherein a sliding window updates to a new frame and takes voting for last 9 frames along with current frame.

15. A system for occupancy detection comprising:
a means for capturing an image;
a means for processing a captured image; and
a means for switching based on detection of objects.
